(19) United States
(12) Patent Application Publication
(10) Pub. No.: US 2026/0330134 A1
(43) Pub. Date: Oct. 22, 2026

(54) SYSTEMS AND METHODS FOR PARSING HYPERTEXT MARKUP LANGUAGE (HTML)

(71) Applicant: Capital One Services, LLC, McLean, VA (US)

(72) Inventor: William George HENDERSON, Austin, TX (US)

(73) Assignee: Capital One Services, LLC, McLean, VA (US)

(21) Appl. No.: 19/184,502

(22) Filed: Apr. 21, 2025

(51) Int. Cl. G06F 40/221; G06F 40/143

(52) U.S. Cl. CPC G06F 40/221; G06F 40/143

(57) ABSTRACT

Described are systems and methods for parsing HyperText Markup Language (HTML), comprising analyzing an HTML data structure based on at least one Cascading Style Sheets (CSS) selector to determine at least one container, filtering the at least one container using at least one exclusion criteria, generating a de-duplication value, wherein the de-duplication value is a count of de-duplicated containers, determining a variance by comparing the de-duplication value to an expected value, determining whether the variance exceeds a variance threshold, and upon determining the variance exceeds the variance threshold, transmitting an initiation protocol to a protocol system.

### TECHNICAL FIELD

Various embodiments of this disclosure relate generally to parsing HyperText Markup Language (HTML) and, more particularly, to systems and methods for improving container filtering and blocking.

### BACKGROUND

Organizations may wish to analyze browser extension functionality, but conventional analysis may prove impossible or difficult. For example, where an advertisement blocking browser extension is not accurately capturing the number of advertisements on a webpage due to inherent analysis challenges, the browser extension may technically be functioning correctly yet outputting an incorrect value. As such, alternative measures of browser extension functionality may result in improved browser extension operation, analysis, etc. while minimizing intrusion in a user's web browsing experience.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for parsing HyperText Markup Language (HTML).

In one aspect, a method for parsing HTML is disclosed. The method may include analyzing, via an analysis system, an HTML data structure based on at least one Cascading Style Sheets (CSS) selector to determine at least one container, filtering, via a filtering system, the at least one container using at least one exclusion criteria, wherein the at least one exclusion criteria parses at least one container element of each container to de-duplicate containers, generating, via a variance system, a de-duplication value, wherein the de-duplication value is a count of de-duplicated containers, determining, via the variance system, a variance by comparing the de-duplication value to an expected value, determining, via the variance system, whether the variance exceeds a variance threshold, and upon determining the variance exceeds the variance threshold, transmitting an initiation protocol to a protocol system.

In another aspect, a system is disclosed. The system may include at least one memory storing instructions, and at least one processor operatively connected to the at least one memory, and configured to execute the instructions to perform operations for parsing HTML. The operations may include analyzing, via an analysis system, an HTML data structure based on at least one Cascading Style Sheets (CSS) selector to determine at least one container, filtering, via a filtering system, the at least one container using at least one exclusion criteria, wherein the at least one exclusion criteria parses at least one container element of each container to de-duplicate containers, generating, via a variance system, a de-duplication value, wherein the de-duplication value is a count of de-duplicated containers, determining, via the variance system, a variance by comparing the de-duplication value to an expected value, determining, via the variance system, whether the variance exceeds a variance threshold, and upon determining the variance exceeds the variance threshold, transmitting an initiation protocol to a protocol system.

In another aspect, a method for parsing HTML is disclosed. The method may include analyzing, via an analysis system, an HTML data structure by matching at least one Cascading Style Sheets (CSS) selector to at least one HTML data structure element to determine at least one container, filtering, via a filtering system, the at least one container using at least one exclusion criteria, wherein the at least one exclusion criteria parses at least one container element of each container to de-duplicate containers based on at least one of a width criteria, a height criteria, a familial criteria, or a spanning criteria, generating, via a variance system, a de-duplication value, wherein the de-duplication value is a count of de-duplicated containers, causing to output, via a user device graphical user interface (GUI), the de-duplication value, determining, via the variance system, a variance by comparing the de-duplication value to an expected value, determining, via the variance system, whether the variance exceeds a variance threshold, and upon determining the variance exceeds the variance threshold, transmitting an initiation protocol to a protocol system, wherein the initiation protocol includes instructions for: generating, via the protocol system, a breakage notification indicating an irregularity associated with the variance, and causing to output, via a third-party GUI, the breakage notification.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for parsing HTML, according to one or more embodiments.

FIGS. 2A-2F depict exemplary methods for parsing HTML, according to one or more embodiments.

FIG. 3 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. The term “container” or the like may be refer to a HyperText Markup Language (HTML) element that groups and encloses or otherwise contains other HTML elements, acting as a wrapper for the content it encloses, providing structure and organization to a webpage or document. The term “child” or the like may refer to objects that are contained within a parent. A “parent” may be an object, such as frames, components and groups, that contain other objects.

In an exemplary use case, a user may wish to determine a more accurate de-duplication value, e.g., in order to assess extension functionality. An HTML data structure for a given webpage may be analyzed to determine at least one container associated with the webpage. In some embodiments, the at least one container may correspond to at least one advertisement. The at least one container may be filtered using at least one exclusion criteria, and a de-duplication value may be determined from the filtered at least one container.

In some embodiments, analyses may be conducted based on the de-duplication value. For example, a variance may be determined by comparing the determined de-duplication value and an expected value. If the variance does not exceed a variance threshold, the de-duplication value may be caused to be output via a GUI of a device associated with a user.

If the variance meets or exceeds the variance threshold, an initiation protocol may be generated. The initiation protocol may be transmitted to a third-party system/device, which may initiate at least one action based on the initiation protocol. For example, the third-party system/device may generate a breakage notification. The breakage notification may indicate an irregularity is associated with the variance. The third-party system/device may cause to output the breakage notification via a third-party GUI of a third-party device associated with a third-party user.

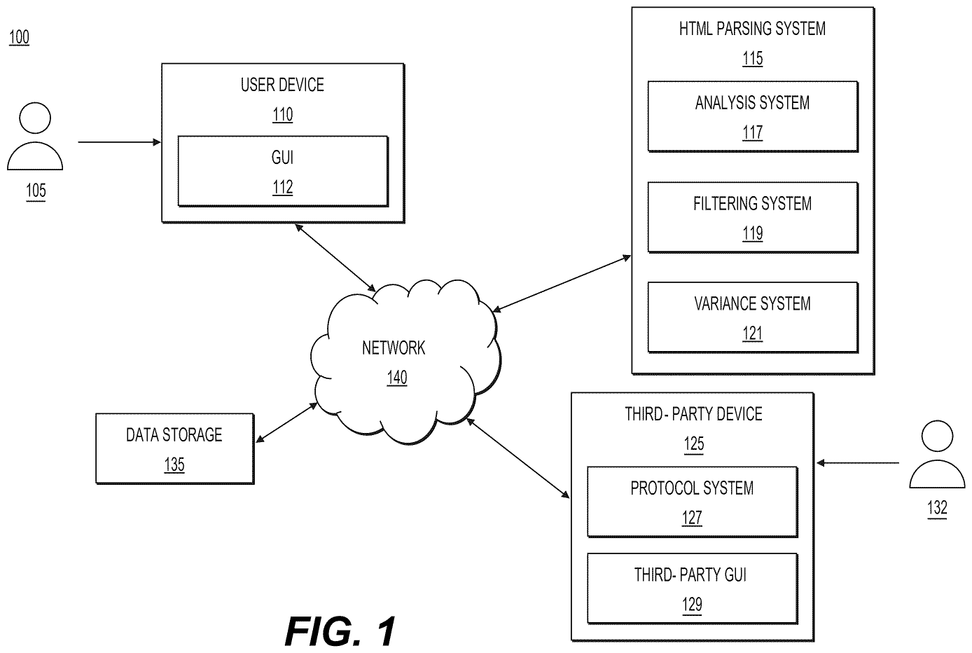

FIG. 1 depicts an exemplary environment 100 for parsing HTML, according to one or more embodiments. In some embodiments, a user 105 may interact with a user device 110 such that a website may be accessed. As depicted in FIG. 1, a user 105 may interact with a graphical user interface (GUI) 112 of user device 110 via at least one user input. User device 110 may be configured to enable user 105 to access or interact with other systems in environment 100.

In some embodiments, user device 110 may be a computer system, e.g., a desktop computer, a laptop computer, a tablet, a smart cellular phone, a smart watch or other electronic wearable, etc. In some embodiments, user device 110 may include one or more electronic applications, e.g., a program, plugin, browser extension, etc., installed on a memory of user device 110. In some embodiments, the electronic applications may be associated with one or more of the other components in the environment 100.

User device 110—or the one or more aspects of user device 110, e.g., GUI 112, etc.—may be configured to obtain data from one or more aspects of environment 100. For example, user device 110 may be configured to receive data from GUI 112 (e.g., via one or more inputs from user 105), an HTML parsing system 115 (or any systems thereof), a third-party device 125 (or any systems thereof), data storage 135, etc. User device 110 may be configured to transmit data to one or more aspects of environment 100, e.g., to GUI 112, an HTML parsing system 115 (or any systems thereof), a third-party device 125 (or any systems thereof), data storage 135, etc.

User device 110 may include GUI 112. GUI 112 may be configured to cause to output a de-duplication value. The de-duplication value may be a count of de-duplicated containers. GUI 112 may be configured to obtain data from one or more aspects of environment 100. For example, GUI 112 may be configured to receive data from user device 110, GUI 112 (e.g., via one or more inputs from user 105), an HTML parsing system 115 (or any systems thereof), a third-party device 125 (or any systems thereof), data storage 135, etc. GUI 112 may be configured to transmit data to one or more aspects of environment 100. For example, GUI 112 may be configured to transmit data to user device 110, an HTML parsing system 115 (or any systems thereof), a third-party device 125 (or any systems thereof), data storage 135, etc.

The HTML parsing system 115 may include an analysis system 117, a filtering system 119, a variance system 121, etc. Analysis system 117 may be configured to analyze an HTML data structure based on at least one Cascading Style Sheets (CSS) selector to determine at least one container. In some embodiments, analysis system 117 may be configured to determine the at least one container by matching at least one CSS selector to at least one HTML data structure element. For example, where at least one CSS selector (e.g., at least one cosmetic rule) is substantially similar to at least one HTML data structure element, analysis system 117 may be configured to determine a match exists. Based on the determined match, analysis system 117 may be configured to determine at least one container.

Analysis system 117 may be configured to obtain data from one or more aspects of environment 100. For example, analysis system 117 may be configured to receive data from user device 110, GUI 112 (e.g., via one or more inputs from user 105), HTML parsing system 115, filtering system 119, variance system 121, third-party device 125 (or any systems thereof), data storage 135, etc. Analysis system 117 may be configured to transmit data to one or more aspects of environment 100. For example, analysis system 117 may be configured to transmit data to user device 110, GUI 112, HTML parsing system 115, filtering system 119, variance system 121, third-party device 125 (or any systems thereof), data storage 135.

Filtering system 119 may be configured to filter the at least one container (e.g., the at least one container determined by analysis system 117 when at least one CSS selector is substantially similar to at least one HTML data structure element). In some embodiments, filtering system 119 may be configured to filter the at least one container based on at least one exclusion criteria. The at least one exclusion criteria may parse at least one container element of each container to de-duplicate containers. The at least one exclusion criteria may be at least one of a width criteria, a height criteria, a familial criteria, a spanning criteria, or any other suitable criteria, or combination thereof.

In some embodiments, filtering system 119 may be configured to filter the at least one container using the width criteria. For example, where a first container and a second container have the same or a substantially similar width, filtering system 119 may be configured to exclude the second container from the de-duplication value and include the first container in the de-duplication value. In another example, where the first container and the second container do not have the same or substantially similar width, filtering system 119 may be configured to include the first container and the second container in the de-duplication value.

In some embodiments, filtering system 119 may be configured to filter the at least one container using the height criteria. For example, where a first container and a second container have the same or a substantially similar height, filtering system 119 may be configured to exclude the second container from the de-duplication value and include the first container in the de-duplication value. In another example, where the first container and the second container do not have the same or substantially similar height, filtering system 119 may be configured to include the first container and the second container in the de-duplication value.

In some embodiments, filtering system 119 may be configured to filter the at least one container using the familial criteria. Filtering system 119 may be configured to analyze the at least one container element of each container to determine whether a second container is a child of a first container. Filtering system 119 may be configured to determine whether a second container is a child of a first container by analyzing the HTML, the Document Object Model (DOM), etc. For example, where a second container is determined to be a child of the first container, filtering system 119 may be configured to exclude the second container from the de-duplication value and include the first container in the de-duplication value. In another example, where a second container is determined not to be a child of the first container, filtering system 119 may be configured to include the first container and the second container in the de-duplication value.

In some embodiments, filtering system 119 may be configured to filter the at least one container using the spanning criteria. Filtering system 119 may be configured to analyze the at least one container element of each container to determine whether a location of a first container is equal to or substantially equal to a location of a second container. For example, where a first container and a second container have the same or a substantially similar location, filtering system 119 may be configured to exclude the second container from the de-duplication value and include the first container in the de-duplication value. In another example, where the first container and the second container do not have the same or substantially similar location, filtering system 119 may be configured to include the first container and the second container in the de-duplication value.

In some embodiments, filtering system 119 may be configured to filter the at least one container based on more than one exclusion criteria. The more than one filters may be applied stepwise, simultaneously, substantially simultaneously, contemporaneously, substantially contemporaneously, etc. For example, where a second container is determined to be a child of the first container, filtering system 119 may be configured to filter the at least one container based on width, height, location, etc. such that, if the second container is determined to have a different or substantially different width, height, location, etc., filtering system 119 may be configured to include the first container and the second container in the de-duplication value despite the second container being the child of the first container.

Filtering system 119 may be configured to obtain data from one or more aspects of environment 100. For example, filtering system 119 may be configured to receive data from user device 110, GUI 112 (e.g., via one or more inputs from user 105), HTML parsing system 115, analysis system 117, variance system 121, third-party device 125 (or any systems thereof), data storage 135, etc. Filtering system 119 may be configured to transmit data to one or more aspects of environment 100. For example, filtering system 119 may be configured to transmit data to user device 110, GUI 112, HTML parsing system 115, analysis system 117, variance system 121, third-party device 125 (or any systems thereof), data storage 135.

Variance system 121 may be configured to generate the de-duplication value. As discussed above, the de-duplication value may be a count of de-duplicated containers. In some embodiments, variance system 121 may be configured to determine the de-duplication value based on a count of the at least one container that remain after being filtered (e.g., by filtering system 119).

Variance system 121 may be configured to determine a variance. The variance may be the difference between the de-duplication value and an expected value. The expected value may be an expected number of de-duplicated containers. For example, where the de-duplication value is five (5) and the expected value is five (5), the variance may be zero (0). In another example, where the de-duplication value is five (5) and the expected value is eight (8), the variance may be three (3).

Additionally, variance system 121 may be configured to compare the variance to a variance threshold. The variance threshold may be customized by a user (e.g., third-party user 132). For example, the variance threshold for a first user may be set to be lower than for a second user. Where the variance is determined to be below the variance threshold, variance system 121 may be configured to transmit instructions (e.g., to GUI 112) to cause to output the de-duplication value.

Where the variance is determined to meet or exceed the variance threshold, variance system 121 may be configured to generate an initiation protocol. The initiation protocol may include instructions (e.g., for third-party device 125) to initiate at least one action. In some embodiments, the initiation protocol may include instructions for generating (e.g., via the protocol system) a breakage notification (e.g., by third-party system). The breakage notification may indicate an irregularity is associated with the de-duplication value or the variance. For example, where the variance exceeds the variance threshold, the breakage notification may indicate this information, the degree to which the variance is exceeded, the determined de-duplication value, the expected value, etc. In some embodiments, the initiation protocol may include instructions for causing to output (e.g., via a third-party GUI) the breakage notification. Variance system 121 may be configured to transmit the initiation protocol (e.g., to protocol system 127).

Variance system 121 may be configured to obtain data from one or more aspects of environment 100. For example, variance system 121 may be configured to receive data from user device 110, GUI 112 (e.g., via one or more inputs from user 105), HTML parsing system 115, analysis system 117, filtering system 119, third-party device 125 (or any systems thereof), data storage 135, etc. Variance system 121 may be configured to transmit data to one or more aspects of environment 100. For example, variance system 121 may be configured to transmit data to user device 110, GUI 112, HTML parsing system 115, analysis system 117, filtering system 119, third-party device 125 (or any systems thereof), data storage 135.

As depicted in FIG. 1, a third-party user 132 may interact with a GUI of third-party device (hereinafter “third-party GUI”) 129 via at least one third-party user input. Third-party device 125 may be configured to enable third-party user 132 to access or interact with other systems in environment 100. In some embodiments, third-party user 132 may interact with a third-party device 125 such that information associated with at least one de-duplication value, a variance, etc. may be managed. A third-party user 132 may be an individual associated with a third party, such as a third party facilitating, monitoring, etc. the HTML parsing discussed herein.

In some embodiments, third-party device 125 may be a computer system, e.g., a desktop computer, a laptop computer, a tablet, a smart cellular phone, a smart watch or other electronic wearable, etc. In some embodiments, third-party device 125 may include one or more electronic applications, e.g., a program, plugin, browser extension, etc., installed on a memory of third-party device 125. In some embodiments, the electronic applications may be associated with one or more of the other components in the environment 100.

Third-party device 125—or the one or more aspects of third-party device 125, e.g., a protocol system 127, a third-party GUI 129, etc.—may be configured to obtain data from one or more aspects of environment 100. For example, third-party device 125 may be configured to receive data from user device 110, GUI 112 (e.g., via one or more inputs from user 105), HTML parsing system 115 (or any systems thereof), protocol system 127, third-party GUI 129 (e.g., via one or more inputs from third-party user 132), data storage 135, etc. Third-party device 125 may be configured to transmit data to one or more aspects of environment 100, e.g., to user device 110, GUI 112, HTML parsing system 115 (or any systems thereof), protocol system 127, third-party GUI 129, data storage 135, etc.

Third-party device 125 may include protocol system 127. Protocol system 127 may be configured to obtain an initiation protocol (e.g., from variance system 121). Based on the initiation protocol, protocol system 127 may be configured to initiate at least one action. As discussed above, the at least one action may include generating (e.g., via the protocol system) the breakage notification (e.g., by third-party system). Protocol system 127 may be configured to transmit the breakage notification (e.g., to third-party GUI 129).

Protocol system 127 may be configured to obtain data from one or more aspects of environment 100. For example, protocol system 127 may be configured to receive data from user device 110, GUI 112 (e.g., via one or more inputs from user 105), HTML parsing system 115 (or any systems thereof), third-party device 125, third-party GUI 129 (e.g., via one or more inputs from third-party user 132), data storage 135, etc. Protocol system 127 may be configured to transmit data to one or more aspects of environment 100. For example, protocol system 127 may be configured to transmit data to user device 110, GUI 112, HTML parsing system 115 (or any systems thereof), third-party device 125, third-party GUI 129, data storage 135, etc.

Third-party device 125 may include third-party GUI 129. Third-party GUI 129 may be configured to cause to output the breakage notification, the de-duplication value, the expected value, etc. Third-party GUI 129 may be configured to obtain data from one or more aspects of environment 100. For example, third-party GUI 129 may be configured to receive data from user device 110, GUI 112 (e.g., via one or more inputs from user 105), HTML parsing system 115 (or any systems thereof), third-party device 125, protocol system 127, data storage 135, etc. Third-party GUI 129 may be configured to transmit data to one or more aspects of environment 100. For example, third-party GUI 129 may be configured to transmit data to user device 110, GUI 112, HTML parsing system 115 (or any systems thereof), third-party device 125, protocol system 127, data storage 135, etc.

Data storage 135 may be configured to receive data from other aspects of environment 100, such as from user device 110, GUI 112 (e.g., via one or more inputs from user 105), HTML parsing system 115 (or any systems thereof), third-party device 125 (or any systems thereof), etc. Data storage 135 may be configured to transmit data to other aspects of environment 100, such as to user device 110, GUI 112, HTML parsing system 115 (or any systems thereof), third-party device 125 (or any systems thereof), etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 135. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, HTML parsing system 115 may be integrated in user device 110 as a browser extension. In another example, data storage 135 may be integrated in third-party device 125. In some embodiments, operations or aspects of one or more of the components discussed above may be distributed amongst one or more other components, e.g., protocol system 127.

In some embodiments, some of the components of environment 100 may be associated with a common entity, while others may be associated with a disparate entity. For example, HTML parsing system 115 may be associated with a common entity (e.g., an entity with which user 105 has an account) while data storage 135 may be associated with a third party (e.g., a provider of data storage services). Any suitable arrangement or integration of the various systems and devices of the environment 100 may be used.

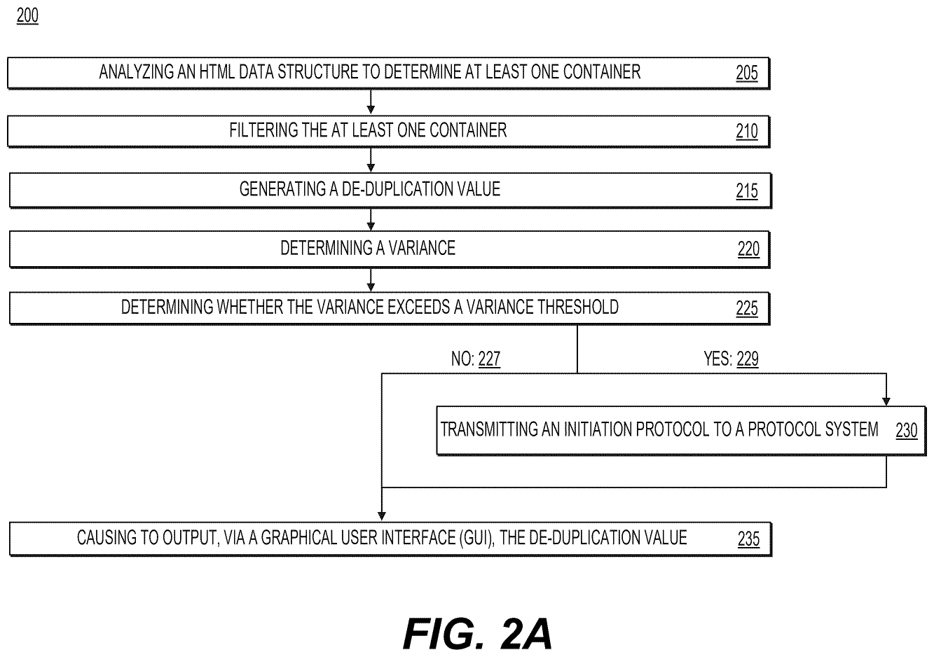

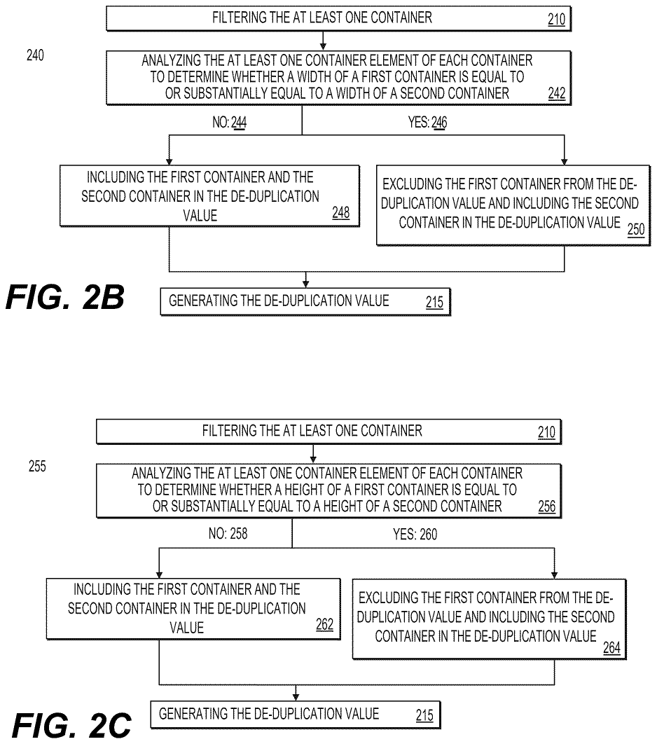

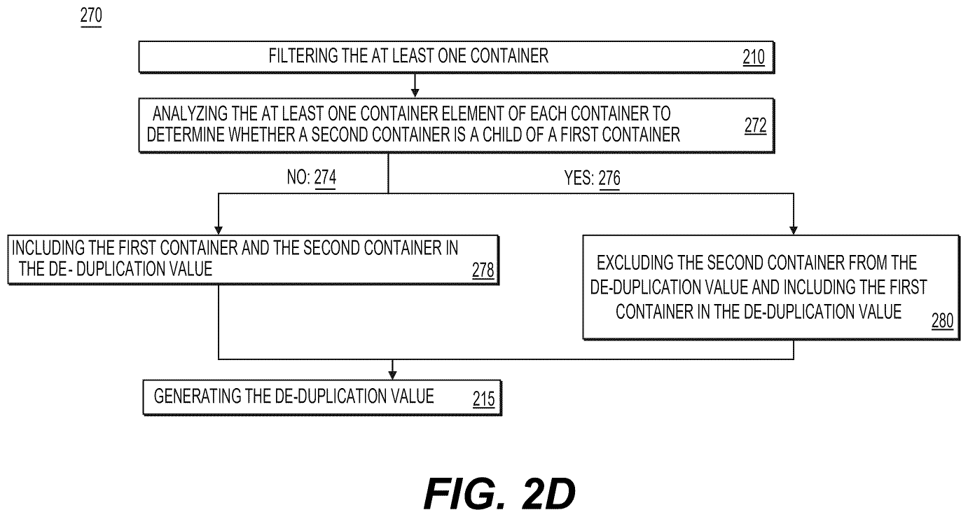

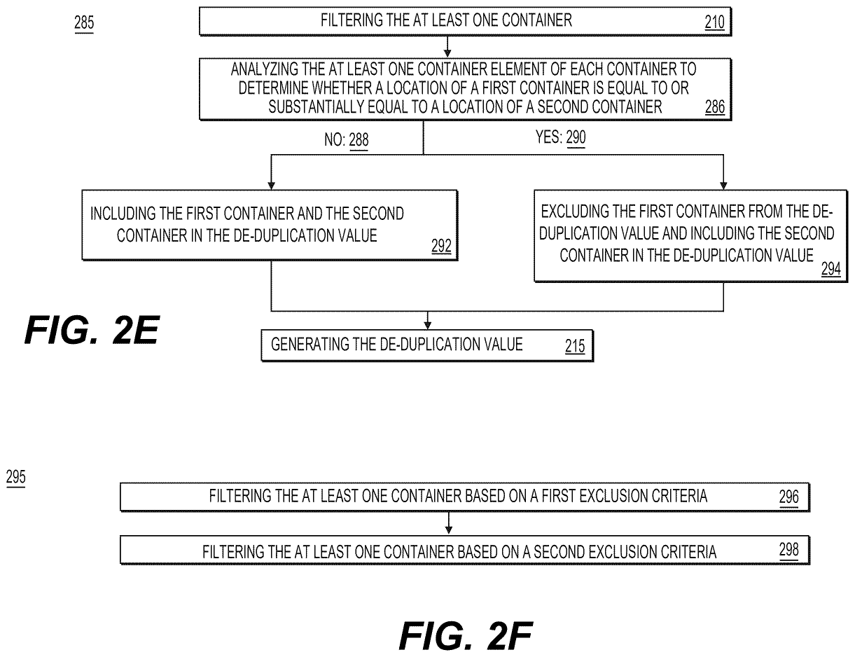

FIG. 2A depicts an exemplary method 200 for parsing HTML, according to one or more embodiments. At step 205, an HTML data structure may be analyzed (e.g., via analysis system 117) to determine at least one container. The HTML data structure may be analyzed based on at least one Cascading Style Sheets (CSS) selector to determine at least one container. In some embodiments, at least one CSS selector may be matched to at least one HTML data structure element to determine the at least one container. For example, where at least one CSS selector (e.g., at least one cosmetic rule) is the same or substantially similar to at least one HTML data structure element, a match may be determined to exist. Based on the determined match, at least one container may be determined.

At step 210, the at least one container may be filtered (e.g., via filtering system 119). In some embodiments, the at least one container may be filtered based on at least one exclusion criteria. As discussed above, the at least one exclusion criteria may parse at least one container element of each container to de-duplicate containers. The at least one exclusion criteria may be at least one of a width criteria, a height criteria, a familial criteria, a spanning criteria, or any other suitable criteria.

As depicted in method 240 of FIG. 2B, the at least one container may be filtered using the width criteria. At step 242, the at least one container element of each container may be analyzed to determine whether a second container has the same or substantially similar width of a first container. At step 250, where a first container and a second container have the same or a substantially similar width (Yes: 246), the second container may be excluded from the de-duplication value and the first container may be included in the de-duplication value. At step 248, where the first container and the second container do not have the same or substantially similar width (No: 244), the first container and the second container may be included in the de-duplication value. At step 215, the de-duplication value may be determined, as discussed in further detail below.

As depicted in method 255 of FIG. 2C, the at least one container may be filtered using the height criteria. At step 256, the at least one container element of each container may be analyzed to determine whether a second container has the same or substantially similar height of a first container. At step 264, where a first container and a second container have the same or a substantially similar height (Yes: 260), the second container may be excluded from the de-duplication value and the first container may be included in the de-duplication value. At step 262, where the first container and the second container do not have the same or substantially similar height (No: 258), the first container and the second container may be included in the de-duplication value. At step 215, the de-duplication value may be determined, as discussed in further detail below.

As depicted in method 270 of FIG. 2D, the at least one container may be filtered using the familial criteria. At step 272, the at least one container element of each container may be analyzed to determine whether a second container is a child of a first container. Whether the second container is the child of the first container may be determined based on analysis of the HTML, the Document Object Model (DOM), etc. At step 278, where the second container is determined not to be the child of the first container (No: 274), the first container and the second container may be included in the de-duplication value. At step 280, where the second container is determined to be the child of the first container (Yes: 276), the first container may be included in the de-duplication value and the second container may be excluded from the de-duplication value. At step 215, the de-duplication value may be determined, as discussed in further detail below.

As depicted in method 285 of FIG. 2E, the at least one container may be filtered using the spanning criteria. At step 286, the at least one container element of each container may be analyzed to determine whether a location of a first container is equal to or substantially equal to a location of a second container. At step 292, where the location of the second container is determined not to be equal to or substantially equal to the location of the first container (No:
288), the first container and the second container may be included in the de-duplication value. At step 294, where the location of the second container is determined to be equal to or substantially equal to the location of the first container (Yes: 290), the first container may be included in the de-duplication value and the second container may be excluded from the de-duplication value. At step 215, the de-duplication value may be determined, as discussed in further detail below.

In some embodiments, the at least one container may be filtered based on at least one exclusion criteria. For example, as depicted in method 295 of FIG. 2F, the at least one container may be filtered based on a first exclusion criteria (see step 296) and a second exclusion criteria (see step 298). As discussed herein, the at least one exclusion criteria may be applied stepwise, simultaneously, substantially simultaneously, contemporaneously, substantially contemporaneously, etc. For example, where a second container is determined to be a child of the first container, the at least one container may also be filtered based on width, height, location, etc. such that, if the second container is determined to have a different or substantially different width, height, location, etc., the first container and the second container may be included in the de-duplication value despite the second container being the child of the first container.

Returning to FIG. 2A, at step 215, the de-duplication value may be generated (e.g., via variance system 121). As discussed herein, the de-duplication value may be a count of de-duplicated containers. In some embodiments, the de-duplication value may be determined based on a count of the at least one container that remain after being filtered (e.g., by filtering system 119).

At step 220, a variance may be determined (e.g., via variance system 121). As discussed herein, the variance may be the difference between the de-duplication value and an expected value. The expected value may be an expected number of de-duplicated containers. For example, where the de-duplication value is five (5) and the expected value is five (5), the variance may be zero (0). In another example, where the de-duplication value is five (5) and the expected value is eight (8), the variance may be three (3).

At step 225, it may be determined whether the variance exceeds a variance threshold (e.g., via variance system 121). In some embodiments, the variance may be compared to the variance threshold to determine whether the variance exceeds the variance threshold. The variance threshold may be customized by a user (e.g., third-party user 132). For example, the variance threshold for a first user may be set to be lower than for a second user. Where the variance is determined to be below the variance threshold (No: 227), variance system 121 may be configured to transmit instructions (e.g., to GUI 112) to cause to output the de-duplication value, at step 235.

Where the variance is determined to meet or exceed the variance threshold (Yes:
229), an initiation protocol may be transmitted (e.g., to protocol system 127), at step 230. In some embodiments, the initiation protocol may be generated in response to the determination that the variance meets or exceeds the variance threshold. As discussed herein, the initiation protocol may include instructions (e.g., for third-party device 125) to initiate at least one action. In some embodiments, the initiation protocol may include instructions for generating (e.g., via the protocol system) a breakage notification (e.g., by third-party system). The breakage notification may indicate an irregularity is associated with the de-duplication value or the variance. For example, where the variance exceeds the variance threshold, the breakage notification may indicate this information, the degree to which the variance is exceeded, the determined de-duplication value, the expected value, etc. In some embodiments, the initiation protocol may include instructions for causing to output (e.g., via third-party GUI 129) the breakage notification. The breakage notification may be caused to be output (e.g., via third-party GUI 129).

At step 235, the de-duplication value may be caused to be output (e.g., via GUI 112). In some embodiments, the de-duplication value may be caused to be output once the de-duplication value is generated (e.g., in response to step 215), in response to determining the variance does not exceed the variance threshold (see step No: 227), in response to determining the variance meets or exceeds the variance threshold (see step Yes: 229), etc.

The systems and methods described herein advantageously improve browser extension functionality. By determining a more accurate de-duplication value (e.g., a count of the number of non-duplicative containers), not only may users better understand browser extension functionality, but the browser extension itself may function better. For example, the browser extension may be able to better predict breakage, malfunction, changes in containers, etc., thereby resulting in improved browser extension functionality.

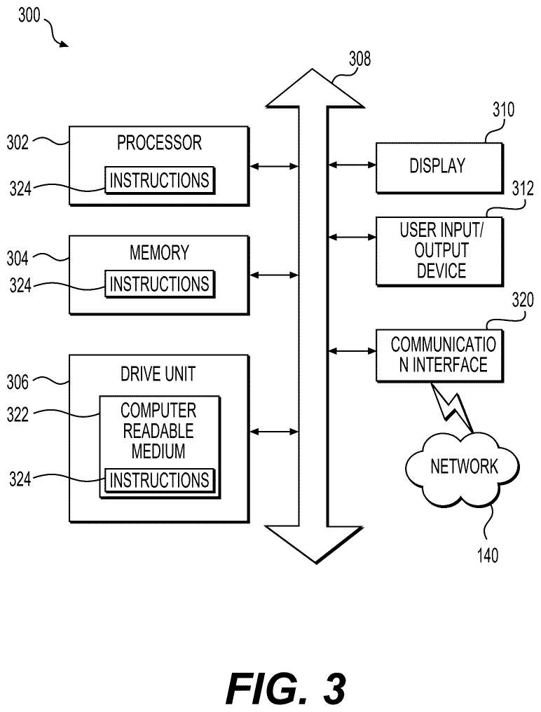

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for parsing HyperText Markup Language (HTML), comprising:
analyzing, via an analysis system, an HTML data structure based on at least one Cascading Style Sheets (CSS) selector to determine at least one container;
filtering, via a filtering system, the at least one container using at least one exclusion criteria, wherein the at least one exclusion criteria parses at least one container element of each container to de-duplicate containers;
generating, via a variance system, a de-duplication value, wherein the de-duplication value is a count of de-duplicated containers;
determining, via the variance system, a variance by comparing the de-duplication value to an expected value;
determining, via the variance system, whether the variance exceeds a variance threshold; and
upon determining the variance exceeds the variance threshold, transmitting an initiation protocol to a protocol system.

2. The method of claim 1, further comprising:
causing to output, via a user device graphical user interface (GUI), the de-duplication value.

3. The method of claim 1, wherein analyzing the HTML data structure further comprises:
matching, via the analysis system, the at least one CSS selector to at least one HTML data structure element to determine the at least one container.

4. The method of claim 1, wherein the at least one exclusion criteria is at least one of a width criteria, a height criteria, a familial criteria, or a spanning criteria.

5. The method of claim 4, wherein filtering the at least one container using the familial criteria comprises:
analyzing, via the filtering system, the at least one container element of each container to determine whether a second container is a child of a first container.

6. The method of claim 5, wherein filtering the at least one container using the familial criteria further comprises:
upon determining the second container is the child of the first container, excluding the second container from the de-duplication value and including the first container in the de-duplication value via the filtering system.

7. The method of claim 5, wherein filtering the at least one container using the familial criteria further comprises:
upon determining the second container is not the child of the first container, including the first container and the second container in the de-duplication value via the filtering system.

8. The method of claim 4, wherein filtering the at least one container using the spanning criteria further comprises:
analyzing, via the filtering system, the at least one container element of each container to determine whether a location of a first container is equal to or substantially equal to a location of a second container.

9. The method of claim 8, wherein filtering the at least one container using the spanning criteria further comprises:
upon determining the location of the first container is equal to or substantially equal to the location of the second container, excluding the first container from the de-duplication value and including the second container in the de-duplication value via the filtering system.

10. The method of claim 8, wherein filtering the at least one container using the spanning criteria further comprises:
upon determining the location of the first container is not equal to or substantially equal to the location of the second container, including the first container and the second container in the de-duplication value via the filtering system.

11. The method of claim 1, wherein the initiation protocol includes instructions for:
generating, via the protocol system, a breakage notification indicating an irregularity associated with the variance; and
causing to output, via a third-party GUI, the breakage notification.

12. A system, the system comprising:
at least one memory storing instructions; and
at least one processor operatively connected to the at least one memory, and configured to execute the instructions to perform operations for parsing HTML, the operations including:
analyzing, via an analysis system, an HTML data structure based on at least one Cascading Style Sheets (CSS) selector to determine at least one container;
filtering, via a filtering system, the at least one container using at least one exclusion criteria, wherein the at least one exclusion criteria parses at least one container element of each container to de-duplicate containers;
generating, via a variance system, a de-duplication value, wherein the de-duplication value is a count of de-duplicated containers;
determining, via the variance system, a variance by comparing the de-duplication value to an expected value;
determining, via the variance system, whether the variance exceeds a variance threshold; and
upon determining the variance exceeds the variance threshold, transmitting an initiation protocol to a protocol system, wherein the initiation protocol includes instructions for:
generating, via the protocol system, a breakage notification indicating an irregularity associated with the variance; and
causing to output, via a third-party GUI, the breakage notification.

13. The system of claim 12, wherein the at least one exclusion criteria is at least one of a width criteria, a height criteria, a familial criteria, or a spanning criteria.

14. The system of claim 13, wherein filtering the at least one container using the familial criteria comprises:
analyzing, via the filtering system, the at least one container element of each container to determine whether a second container is a child of a first container.

15. The system of claim 14, wherein filtering the at least one container using the familial criteria further comprises:
upon determining the second container is the child of the first container, excluding the second container from the de-duplication value and including the first container in the de-duplication value via the filtering system.

16. The system of claim 14, wherein filtering the at least one container using the familial criteria further comprises:
upon determining the second container is not the child of the first container, including the first container and the second container in the de-duplication value via the filtering system.

17. The system of claim 13, wherein filtering the at least one container using the spanning criteria further comprises:
analyzing, via the filtering system, the at least one container element of each container to determine whether a location of a first container is equal to or substantially equal to a location of a second container.

18. The system of claim 17, wherein filtering the at least one container using the spanning criteria further comprises:
upon determining the location of the first container is equal to or substantially equal to the location of the second container, excluding the first container from the de-duplication value and including the second container in the de-duplication value via the filtering system.

19. The system of claim 17, wherein filtering the at least one container using the spanning criteria further comprises:
upon determining the location of the first container is not equal to or substantially equal to the location of the second container, including the first container and the second container in the de-duplication value via the filtering system.

20. A method for parsing HTML, comprising:
analyzing, via an analysis system, an HTML data structure by matching at least one Cascading Style Sheets (CSS) selector to at least one HTML data structure element to determine at least one container;
filtering, via a filtering system, the at least one container using at least one exclusion criteria, wherein the at least one exclusion criteria parses at least one container element of each container to de-duplicate containers based on at least one of a width criteria, a height criteria, a familial criteria, or a spanning criteria;
generating, via a variance system, a de-duplication value, wherein the de-duplication value is a count of de-duplicated containers;
causing to output, via a user device graphical user interface (GUI), the de-duplication value;
determining, via the variance system, a variance by comparing the de-duplication value to an expected value;
determining, via the variance system, whether the variance exceeds a variance threshold; and
upon determining the variance exceeds the variance threshold, transmitting an initiation protocol to a protocol system, wherein the initiation protocol includes instructions for:
generating, via the protocol system, a breakage notification indicating an irregularity associated with the variance; and
causing to output, via a third-party GUI, the breakage notification.
